(19) United States
(12) Patent Application Publication
(10) Pub. No.: US 2010/0181284 A1
(43) Pub. Date: Jul. 22, 2010

(54) METHOD OF OBTAINING ELECTRONIC CIRCUITRY FEATURES

(75) Inventors: Yueh-Ling Lee, Raleigh, NC (US); Glenn Oliver, New Hill, NC (US); Shane Fang, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, WILMINGTON, DE (US)

(21) Appl. No.: 12/369,798

(22) Filed: Feb. 12, 2009

Related U.S. Application Data
(60) Provisional application No. 61/145,672, filed on Jan. 19, 2009.
(60) Provisional application No. 61/145,679, filed on Jan. 19, 2009.
(60) Provisional application No. 61/145,687, filed on Jan. 19, 2009.

(51) Int. Cl. B44C 1/22

(52) U.S. Cl. 216/13

(57) ABSTRACT

The present disclosure relates to a method of obtaining fine circuitry features by positioning a circuit board precursor, the circuit board precursor having a cover layer and an insulating substrate, in proximity to a source of laser radiation. Selectively laser ablating through the cover layer and into the underlying insulating substrate and then treating with water, dilute alkali solution or dilute acid solution to remove the cover layer to reveal one or more circuitry features on the insulating substrate that are smaller than if a cover layer is not used.

### FIELD OF INVENTION

The present disclosure relates generally to electronic circuit materials. More specifically, the present disclosure is directed to a method of producing fine circuitry features.

### BACKGROUND OF THE INVENTION

Printed circuit boards typically comprise an insulating substrate which supports a thin conducting layer in a pattern designed for a specific application. The patterned conducting layer (also referred to as a printed circuit), is the means for carrying electrical voltages and currents between various electrical components, such as resistors, capacitors, integrated circuits and other electronic devices.

To meet operational requirements for high-performance chips, such as microprocessors, chip sets, and graphic chips, it is necessary to enhance the functions of circuit boards regarding, for example, chip signal transmission, bandwidth, and impedance control, in order to accordingly answer to the trends of high I/O number packages. However, to fit in with the developing trend of semiconductor package towards light weight, small size, multiple functions, high speed, and high frequency, circuit boards for packaging semiconductor chips have been trending towards finer lines, smaller through holes or vias and decreasing thickness of the entire assembly. Thus, a need exists for producing increasingly finer circuit lines.

### BRIEF DESCRIPTION OF THE DRAWINGS

The invention is herein described, by way of example only, with reference to the accompanying drawings, wherein:

FIG. 1 is a cross-sectional drawing of a portion of a circuit board precursor having a cover layer and an insulating substrate;

FIG. 2A is a cross-sectional drawing of a portion of a circuit board precursor after laser ablating circuitry features on the circuit board precursor when a sacrificial cover layer is used;

FIG. 2B is a cross-sectional drawing of an insulating substrate where the sacrificial cover layer is removed after laser ablation but prior to metallization;

FIG. 3A is a cross-sectional drawing similar to that of FIG. 2A, illustrating a portion of a circuit board precursor after laser ablating circuitry features on the circuit board precursor when a strippable cover layer is used;

FIG. 3B is a cross-sectional drawing of a portion of a circuit board precursor after metallization when a strippable cover layer is used;

FIG. 3C is a cross-sectional drawing of a portion of a insulating substrate where the strippable cover layer is removed after metallization;

FIG. 4A is a cross-sectional drawing of an insulating substrate illustrating measurement of trench width when a cover layer is used and removed;

FIG. 4B is a top view of an insulating substrate illustrating measurement of trench width when a cover layer is used and removed;

FIG. 5A is a cross-sectional drawing of an insulating substrate illustrating measurement of trench width when a cover layer is not used;

FIG. 5B is a top view of an insulating substrate illustrating measurement of trench width when a cover layer is not used.

### DESCRIPTION OF THE PREFERRED EMBODIMENTS

The foregoing general description and the following description are exemplary and explanatory only and are not restrictive of the invention, as defined in the appended claims.

The term “activatable” herein denotes induced to have a much greater reactivity favorable to metallization.

The term “circuitry features” herein denotes a trough(s), rout(s), trench(es), via(s), routed line(s), routed trace(s) prior to metallization. The terms may be used interchangeably. The term “circuitry features” for the purpose of this disclosure also refer to circuit(ry) line(s), circuit(ry) trace(s), trough(s), trench(es), and via(s) after metallization. The terms may be used interchangeably and can be used interchangeably with “patterned conductive layer”.

The term “circuit board precursor” herein denotes an insulating substrate layer with a cover layer where the cover layer is in direct contact with the insulating substrate.

The term “fine” (finer) herein denotes thin (thinner), slender, smaller or narrow (narrower). For the purpose of this disclosure the terms may be used interchangeably.

The term “focal plane” herein denotes the upper surface of the circuit board precursor.

The term “insulating” herein denotes electrically insulating.

The term “laser dye” herein denotes a material that accelerates the absorption of laser radiation due to its absorption peak close to the wave length of the laser used.

The term “metallization” herein denotes the deposition of metal on to a surface. The deposition of metal may only be on part of a surface. More specifically, the term denotes deposition of metal on circuitry features. The term metallization may be used interchangeably with the term metallizing and plating.

The term “over-plating” herein denotes excess metal build-up laterally and upwardly of the circuitry features.

The term “soluble” herein denotes suspension or dissolvable wholly, or in-part, in a liquid or denotes the ability of a coating to be removed by the action of a liquid and may just be active enough to penetrate underneath of a layer and to thus destroy its adhesion to any underlying layer or substrate, whereupon the layer is just swept away.

The present disclosure is directed to a method of obtaining circuitry features. The method and materials are well suited for producing fine circuitry features. The method of the present disclosure uses a cover layer to produce finer circuitry features. The method comprises: positioning a circuit board precursor in proximity to a source of laser radiation; selectively laser ablating through the cover layer and into at least a portion of the underlying insulating substrate; and treating to remove the cover layer (prior to metallization or after metallization will depend on the cover layer used) to reveal one or more circuitry features on the insulating substrate that are smaller than if a cover layer is not used. In some embodiments, the circuitry features are from 2 to 98% smaller. In some embodiments, the circuitry features are from 4 to 97% smaller. In another embodiment, the circuitry features are from 10 to 80% smaller. In another embodiment, the circuitry features are 20 to 70% smaller. In yet another embodiment, the circuitry features are 30 to 50% smaller. In another embodiment, the circuitry features are at least 4% smaller when a cover layer is used. In some embodiments, the circuitry features are between and optionally including any two of the following numbers 2, 4, 6, 8, 10, 12, 14, 16, 18, 20, 24, 28, 30, 34, 38, 40, 44, 48, 50, 54, 58, 60, 64, 68, 70, 74, 78, 80, 84, 88, 90, 94, 95, 96, 97 and 98% smaller.

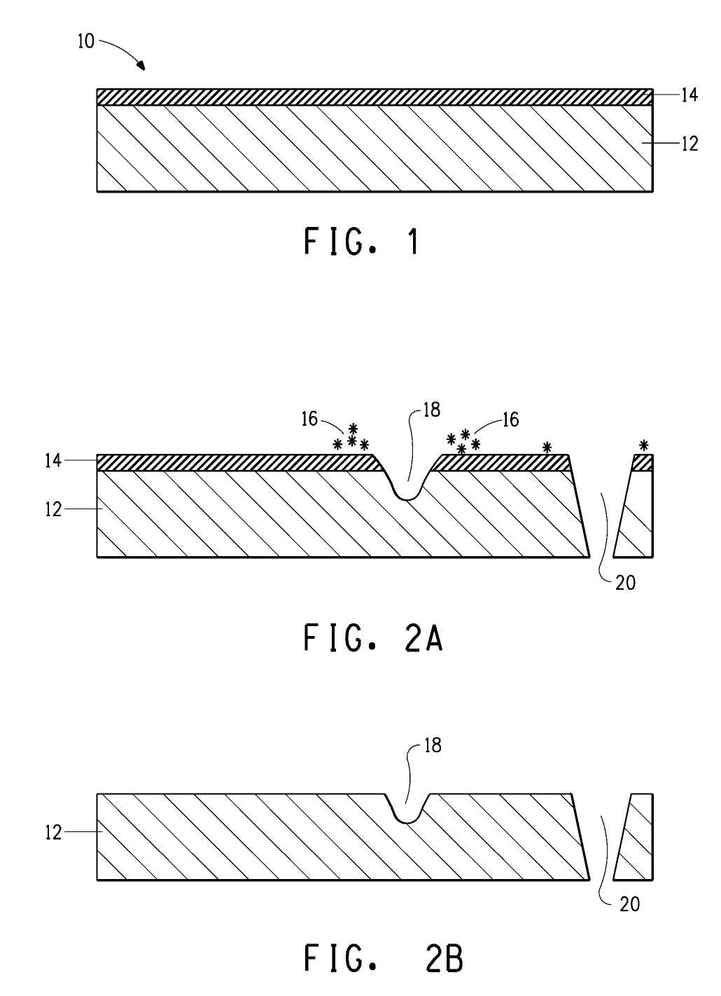

FIG. 1 illustrates a circuit board precursor 10. The circuit board precursor 10 comprises a cover layer 14 and an insulating substrate 12. The cover layer 14 is located over the insulating substrate 12 and is in direct contact with the insulating substrate 12.

### Cover Layer

FIG. 2A illustrates one embodiment of the present disclosure. The cover layer 14 is a sacrificial cover layer and functions as a protective layer upon which ablation debris 16 will tend to locate as the laser (or similar type energy source) ablates through the cover layer 14 and in to the insulating substrate 12. The laser ablation process tends to act somewhat like a plowing process, producing circuitry features such as a trench 18 or a via 20. Ablation debris will tend to comprise insulating polymeric matrix material. Metallization of the ablation debris is generally undesirable and can lead to problems in electrical performance and/or reliability of the final printed wiring board product. Ideally, metallization should occur largely, if not exclusively, within the laser ablated trench 18 or via 20 in the insulating substrate 12.

Regardless of the type of cover layer used, the cover layer must be thermally stable to withstand the heat generated during the laser ablation process. The amount of heat generated during the laser ablation process will vary depending on the type of laser used and the conditions at which the laser is operated. The cover layer must have good adhesion to the insulating substrate.

In some embodiments, the sacrificial cover layer comprises an amount between and optionally including 80, 82, 84, 86, 88, 90, 92, 94, 96, 98 and 100 weight % of a soluble polymeric matrix material. In some embodiments, the soluble polymeric matrix material is a water soluble polymeric matrix material. Not all water soluble polymeric matrix materials are useful according to the present disclosure. The water soluble matrix material must be thermally stable to withstand the heat generated during the laser ablation process. Water soluble polymeric matrix materials having a low Tg will not be thermally stable to withstand the heat generated during the laser ablation process. Poly vinyl alcohol, while being water soluble, has a low Tg and would not be useful as sacrificial cover layers of the present disclosure. In some embodiments, the water soluble polymeric matrix material has a Tg of at least 100° C. In some embodiments, the water soluble polymeric matrix material has a Tg of at least 110° C. In some embodiments, the water soluble polymeric matrix material has a Tg of at least 120° C. In some embodiments, the water soluble polymeric matrix material has a Tg of at least 137° C. In some embodiments, the water soluble polymeric matrix material is derived from a thermally stable hydrophilic monomer selected the group consisting of acryamide, ethylene oxide, propylene oxide, vinyl pyrrolydinone, acrylic acid, methacrylic acid, maleic acid, mixtures and derivatives thereof. In some embodiments, soluble polymeric matrix material derived from the thermally stable hydrophilic monomer(s) may vary in molecular weight and the ratio of monomers can vary.

In some embodiments, the sacrificial cover layer has a thickness between and optionally including 0.5, 1, 5, 10, 15, 20, 25, 30, 35, 40, 45, 50, 55, 60, 65, 70, 75, 80, 85, 90, 95 and 100 micrometers.

Referring now to FIG. 2B, the sacrificial cover layer can be removed after laser ablation and prior to metallization. In such embodiments, once the cover layer is removed, the ablated insulating substrate 12 is exposed and is substantially, if not wholly, free of ablation debris at the insulating substrate surface.

In some embodiments, the sacrificial cover layer is removed by treatment with a liquid selected from the group consisting of water, dilute alkali solution, dilute acid solution and organic solvents. This liquid does not necessarily dissolve the entire cover layer, but may just be active enough to penetrate underneath the layer and to thus destroy its adhesion to the underlying insulating substrate, whereupon cover layer 14 is just swept away. Regardless, the wash solution should be selected for its ability to dissolve or otherwise remove the cover layer. In some embodiments, the sacrificial cover layer may be removed under a spray of water. In another embodiment, the sacrificial cover layer may be removed by immersing the pre-metalized circuit board precursor in the water, dilute alkali solution, dilute acid solution and organic solvents.

In some embodiments, the cover layer is a strippable cover layer. The strippable cover layer comprises an amount between and optionally including 80, 82, 84, 86, 88, 90, 92, 94, 96, 98 and 100 weight % of a soluble polymeric matrix material. In some embodiments, the soluble polymeric matrix material is selected from the group consisting of chitosan, methylglycol chitosan, chitosan oligosaccharide lactate, glycol chitosan, poly(vinyl imidazole), polyallylamine, polyvinylamine, polyetheramine, cyclen(cyclic polyamine), polyethylene amine (linear, or branched, or benzylated), poly(N-methylvinylamine), polyoxyethylene bis(amine), N′-(4-Benzyloxy)-N,N-dimethylformamidine polymer-bound (amidine resin), poly(ethylene glycol)bis(2-aminoethyl), poly(2-vinylpyridine), poly(4-vinylpyridine), poly(2-vinylpyridine N-oxide), poly(4-vinylpyridine N-oxide), poly(4-vinylpyridine-co-divinylbenzene), poly(2-vinylpyridine-co-styrene), poly(4-vinylpyridine-co-styrene), poly(4-vinylpyridine)-2% crosslinked, poly(4-aminostyrene), poly(aminomethyl)polystyrene, poly(dimethylaminoethylmethacrylate), poly(t-butylaminotheylmethacrylate), poly(dimethylaminoethylmethacrylate), poly(aminoethylmethacrylate), copolymer of styrene and dimethylaminopropylamine maleimide, and mixtures thereof. Not all soluble polymeric matrix materials are useful as a strippable cover layer according to the present disclosure. The soluble matrix material must be thermally stable to withstand the heat generated during the laser ablation process. In some embodiments, the strippable cover layer soluble polymeric matrix material has a Tg of at least 100° C. In some embodiments, the strippable cover layer soluble polymeric matrix material has a Tg of at least 110° C. In some embodiments, the strippable cover layer soluble polymeric matrix material has a Tg of at least 120° C. In some embodiments, the strippable cover layer soluble polymeric matrix material has a Tg of at least 137° C. In some embodiments, the thickness of the strippable cover layer should be thick enough to give minimal mechanical ability yet easily removed with metalized debris on its surface. In some embodiments, the thickness of the strippable cover layer will depend on the selection of soluble polymeric matrix material and the solvent used to remove the strippable cover layer. In some embodiments, the strippable cover layer has a thickness between and optionally including 2, 5, 10, 15, 20, 25, 30, 35, 40, 45, 50, 55, 60, 65, 70, 75, 80, 85, 90, 95, 100 110, 120, 130, 140, 150, 160, 170, 180, 190, 200, 210, 220, 230, 240 and 250 micrometers.

The strippable cover layer can withstand a solvent with a pH greater than 7 and is soluble in solvent with a pH less than 7. The strippable cover is capable of withstanding the alkaline clean bath and electroless plating bath. In some embodiments, the strippable cover layer can be removed after metallization. The strippable cover layer removes any over-plating and debris which has been metallized and partially removes or confines over-plating to provide cleaner circuitry features. Over-plating of circuitry features can cause shorts. An additional debris removal process after laser imaging is optional. Pressure sensitive adhesive tapes can be laminated on the substrate to remove debris for this additional cleaning process. Rubber rollers can also be applied to lift debris from the imaged substrate with the assistance of pressure sensitive adhesive coatings.

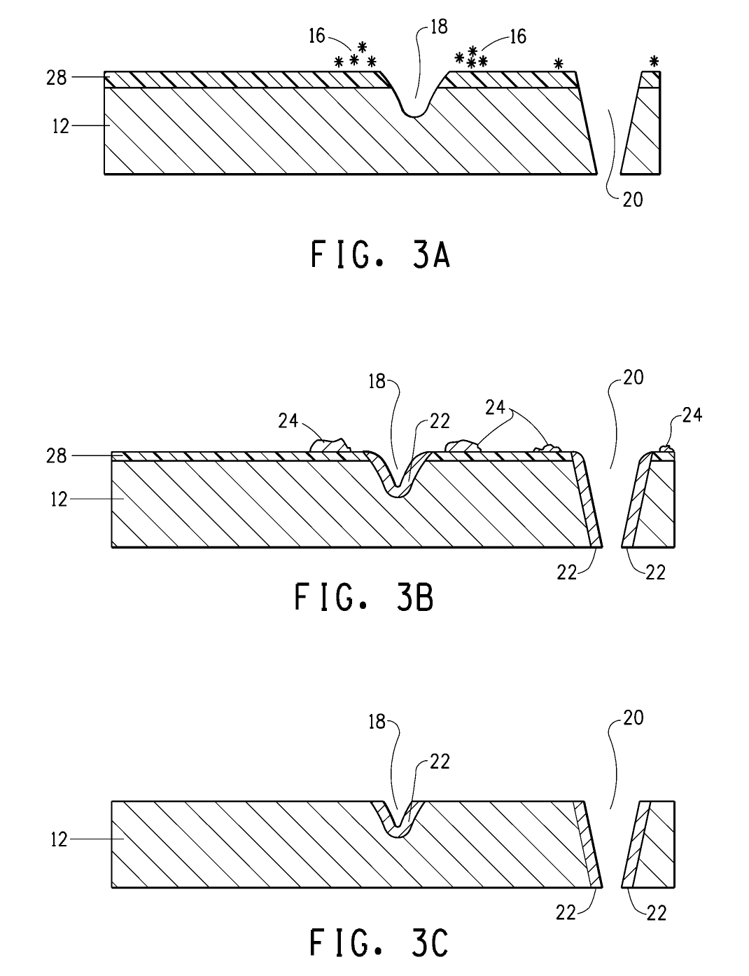

FIG. 3A illustrates one embodiment of the present disclosure. The cover layer is a strippable cover layer 28 that functions as a protective layer upon which ablation debris 16 will tend to locate as the laser (or similar type energy source) ablates through the strippable cover layer 28 and in to the insulating substrate 12 producing circuitry features such as a trench 18 or a via 20. A strippable cover layer 28 can be kept until after metallization, as illustrated in FIG. 3B. In such embodiments, the trough 18 (or via 20) is filled with metal 22 during metallization. In such embodiments, after removal of the strippable cover layer, as illustrated in FIG. 3C, the insulating substrate 12 is exposed and the circuitry features will tend to have very clean, sharp metallization 22 at the trench or via edge, and very little, if any, unwanted metallization outside the ablated trench 18 or via 20.

In some embodiments, the strippable cover layer is soluble in water or weak acid water mixtures. In some embodiments, the strippable cover layer is soluble in organic solvents. Regardless, the wash solution should be selected for its ability to dissolve or otherwise remove the cover layer.

One advantage of the cover layers of the present disclosure is that removal of the cover layers does not require the harsh strippers that many inorganic cover layers do. The harsh strippers are less desirable from environmental and process handling perspectives.

In embodiments where the cover layer is a strippable cover layer, the strippable cover layer can be removed either before or after metallization. The metallization chemistry and metallization processing can be adjusted or fine tuned so that metallization substantially stops where intended, such as, at the surface of the trench or extending as a mound beyond the trench upper surface. In some embodiments, metallization occurs at the cover layer ablated surface inside the circuitry feature. In another embodiment, metallization does not occur at the cover layer ablated surface inside the circuitry feature.

In some embodiments, a sacrificial cover layer and a strippable cover layer are used in combination. In some embodiments, the sacrificial cover layer is adjacent to and in direct contact with the strippable layer and the insulating substrate is adjacent to and in direct contact with the strippable layer on the opposite side of the strippable layer from the sacrificial layer.

One advantage of having fine circuitry lines embedded in the insulating substrate is that higher adhesion of the circuitry features (conductor) to the substrate is achieved. For finer circuitry lines, the thickness of the lines (or depth of the trench) compared to the width is much larger in proportion than for wider lines. As this proportion gets higher, the adhesion benefit becomes proportionally greater since more of the circuitry line is in contact with the insulating substrate for embedded conductors. When the circuitry lines are not embedded in the insulating substrate, only the bottom surface of the circuitry line is adhered to the insulating substrate resulting in lower adhesion strength.

The cover layer comprises a laser dye. The addition of laser dyes can promote photodecomposition and control thermal dissipation. Laser dyes aid in the absorption laser energy. As a result, the laser ablated circuitry features will have high resolution with well defined geometry and sharp edge. The laser dye will also increase the speed of the laser ablation process enabling faster production of circuit boards. The cover layers of the present disclosure ablate faster than the insulating substrate. The choice of laser dye will depend on the wavelength of the laser used. In some embodiments, the sacrificial cover layer comprises a laser dye present in the amount between and optionally including 0.1, 0.2, 0.4, 0.6, 0.8, 1, 2, 4, 6, 10, 12, 14, 16, 18 and 20 weight percent. In some embodiments, the strippable cover layer contains a laser dye present in the amount between and optionally including 0.1, 0.2, 0.4, 0.6, 0.8, 1, 2, 4, 6, 10, 12, 14, 16, 18 and 20 weight percent. In some embodiments, any one of the cover layers, used individually or in combination, contain a laser dye. In some embodiments the laser dye has an absorption peak between and optionally including 0.2, 0.3, 0.355, 0.4, 0.5, 0.532, 0.6, 0.7, 0.8, 0.9, 1.0, 1.06, 1.1, 1.2, 1.3, 1.4, 1.5, 1.6, 1.7, 1.8, 1.9, 2.0, 5, 10, and 10.6 micrometers. In some embodiments, the laser dye has an absorption peak from 0.2 to 10.6 micrometers.

In some embodiments the laser dye for a 3× solid state laser (ultraviolet wavelength of approximately 355 nm) is selected from, but not limited to, Stilbene 420: 2,3″-([1,1′-biphenyl]-4,4′-diyldi-2,1-ethenediyl)bis-benzenesulfonic acid disodium salt, Carbostyril 165: 7-dimethylamino-4-methylcarbostyril, Coumarin 450: 7-(ethylamino)-4,6-dimentyl-2H,-1-benzopyran-2-one), Coumarin 445: 7-(ethylamino)-4-mentyl-2H,-1-benzopyran-2-one), Coumarin 440: 7-amino-4-mentyl-2H,-1-benzopyran-2-one), Coumarin 460: 7-(ethylamino)-4-mentyl-2H,-1-benzopyran-2-one), Coumarin 481: 7-(diethylamino)-4-(trifluoromethyl)-2H,-1-benzopyran-2-one), Coumarin 487, Coumarin 500: 7-(ethylamino)-4-(trifluoromethyl)-2H,-1-benzopyran-2-one), Coumarin 503: 7-(ethylamino)-6-(trifluoromethyl)-2H,-1-benzopyran-2-one), BPBD-365, 2-[1,1′-biphenyl]-4-yl-5-[4-(1,1-dimentylethyl)phenyl]-1,2,4-oxadiazole, PBD, 2-[1,1′-biphenyl]-4-yl-5-phenyl]-1,3,4-oxadiazole, PPO, 2-5-diphenyl-oxadiazole, QUI, 3,5,3″″,5″″-tetra-t-butyl-p-quinquephenyl, BBQ,4,4″″-bis[(2-butyloctyl)oxy]-1,1′4′,1″,4″,1′″-quaterphenyl, 2-(1-naphthyl)-5-phenyl-oxazole, PBBO, 2-[1,1′-biphenyl]4-yl-6-phenyl-benzoxazole, DPS, 4,4″-(1,2,-ethenediyl)bis-1,1′-biphenyl, POPOP, 2,2′-(1,4,-phenylene)bis[5-phenyl-oxazole], Bis-MSB, 1,4-bis[2-(2-methylphenyl)ethenyl]-benzene, 5-Phenyl-2-(4-pyridyl)oxazole, 4-methyl-7-(4-morpholinyl)-2H-pyrano[2,3-b]pyridine-2-one, 7-(diethylamino-2H-1-benzopyran-2-one, 7-(dimethylamino)-4-methoxy-1,8-naphthyridin-2(1H)-one, 1,2,3,8-tetrahydro-1,2,3,3,8-pentamethyl-5-(trifluoromethyl)-7H-pyrrolo[3,2-g]quinoolin-7-one, 6,7,8,9-tetrahydro-6,8,9-trimethyl-4-(trifluoromethyl)-2H-pyrrolo[3,2-b][1,8]naphthyridin-2-one, 7-Amino-4-methyl-2(1H)-quinolinone, 2,3,6,7-tetrahydro-1H,5H,1,1H-[1]benzopyrrano[6,7,8-ii]-quinoliz-11-one, EXALITE 376, EXALITE 384, EXALITE 389, EXALITE 392A, EXALITE 398, EXALITE 404, EXALITE 411, EXALITE 416, EXALITE 417, EXALITE 428, EXALITE 392E, EXALITE 400E, EXALITE 377E and mixtures thereof.

In another embodiment, the laser dye for an excimer laser is selected from, but not limited to, p-terphenyl, 1,1′,4′,1′-terphenyl, 2″,3,3″,3′″-tetramethyl-1,1,4′,1″,4″,1′″-quaterphenyl, 2-methyl-5-t-butyl-p-quaterphenyl, EXALITE 348, EXALITE 351 EXALITE 360: 2,3,2′″,5′″-tetramethyl-p-quaterphenyl, P-Quaterphenyl, 1,1′4′,1″,4″,1′″-quaterphenyl and mixtures thereof.

In yet another embodiment, the laser dye for a IR laser is selected from, but not limited to, 8-[[3-[(6,7-Dihydro-2,4-diphenyl-5H-1-benzopyran-8-yl)methylene]-2-phenyl-1-cyclohexen-1-yl]methylene]-5,6,7,8-tetrahydro-2,4-diphenyl-1-benzopyrylium tetrafluoroborate (IR-1100), 4-[2-[2-Chloro-3-[(2,6-diphenyl-4H-thiopyran-4-ylidene)ethylidene]-1-cyclohexen-1-yl]ethenyl]-2,6-diphenylthiopyrylium tetrafluoroborate (IR-1061), 1-Butyl-2-[2-[3-[(1-butyl-6-chlorobenz[cd]indol-2(1H)-ylidene)ethylidene]-2-chloro-5-methyl-1-cyclohexen-1-yl]ethenyl]-6-chlorobenz[cd]indolium tetrafluoroborate (IR-1050), 1-Butyl-2-[2-[3-[(1-butyl-6-chlorobenz[cd]indol-2(1H)-ylidene)ethylidene]-2-chloro-1-cyclohexen-1-yl]ethenyl]-6-chlorobenz[cd]indolium tetrafluoroborate (IR-1048), 4-[2-[3-[(2,6-Diphenyl-4H-thiopyran-4-ylidene)ethylidene]-2-phenyl-1-cyclohexen-1-yl]ethenyl]-2,6-diphenylthiopyrylium tetrafluoroborate (IR-1040), 4-[2-[2-Chloro-3-[(2-phenyl-4H-1-benzopyran-4-ylidene)ethylidene]-1-cyclohexen-1-yl]ethenyl]-2-phenyl-1-benzopyrylium (IR-27), 4-(7-(2-phenyl-4H-1-benzothiopyran-4-ylidene)-4-chloro-3,5-trimethylene-1,3,5-heptatrienyl)-2-phenyl-1-benzothiopyrylium perchlorate (IR 26), 3-ethyl-2[[3-[3-[(3-ethyl-2(3H)-benzothiazolylidene)methyl]5,5-dimethyl-2-cyclohexen-1-ylidene]-1-propenyl]-5,5-dimethyl-2-cyclohexen-1-ylidene]methyl]-benzothiazolium perchlorate (DNTPC-P), 3-ethyl-2[[3-[3-[(3-ethylnaphthol[2,1-d]thiazol-2(3H)-ylidene)methyl]-5,5-dimethyl-2-cyclohexen-1-ylidene]-1-propenyl]-5,5-dimethyl-2-cyclohexen-1-ylidene]methyl]naphtha[2,1-d]thiazolium perchlorate (DNDTPC-P) and mixtures thereof.

In yet another embodiment, the laser dye for a 2× SOLID STATE LASER (visible wavelength of approximately 532 nm) is selected from, but not limited to, Fluorol 555, LDS 698, DCM, LDS 722, Disodium Fluorescein, Rhodamine 560, Fluorescein, LDS 821, LD 688, Pyrromethene 567, 1,3,5,7,8-pentamethyl-2,6-diethylpyrromethene-difluoroborate comples, Rhodamine 575, Pyrromethene 580, Pyrromethene 597, LDS 720, LDS 751, styril 8, Rhodamine 590, Rhodamine 610, LDS 759, LDS 798, Pyrromethene 605, 8-acetoxymethyl-2,6-diethyl-1,3,5,7-tetramethyl pyrromethene fluoroborate, LDS 750, Rhodamine 640 Per, Sulforhodamine 640, DODC Iodide, Kiton Red 620, LDS 925, Pyrromethene 650, LDS 765, LDS 730, LDS 867, 1,1′-Diethyl-2,2′-dicarbocyanine iodide, LD 690 perchlorate, 1,1′-Diethyl-4,4′-carbocyanine iodide, Cresyl Violet 670, 5-imino-5H-benzo[a]phenoxazin-9-amine monoperchlorate, 3,3′ Diethylthiadicarbocyanine iodide, 1,3-Bis[4-(dimethylamino)-2-hydroxyphenyl]-2,4-dihydroxycyclobutenediylium dihydroxide, bis(inner salt), Propyl Astra Blue Iodide, iodide 1,1′,3,3,3′,3′-Hexamethyl-4,5,4′,5′-dibenzoindodicarbocyanine (IR-676) and mixture thereof.

In yet another embodiment, the laser dye for a GaAs laser is selected from, but not limited to, 5,5′-Dichloro-11-diphenylamino-3,3′-diethyl-10,12-ethylenethiatricarbocyanine perchlorate (IR-140), 1,1′,3,3,3′,3′-Hexamethylindotricarbocyanine, 1,1′,3,3,3′,3′-Hexamethylindotricarbocyanine iodide, 1,1′-Diethyl-2,2′-quinotricarbocyanine iodide, Bis[5-[[4-(dimethylamino)phenyl]imino]-8(5H)-quinolinone]nickel(II), 2,4-Di-3-guaiazulenyl-1,3-dihydroxycyclobutenediylium dihydroxide bis(inner salt), 3,3′-Diethylthiatricarbocyanine iodide, 3,3′-Diethylthiatricarbocyanine perchlorate Dimethyl{4-[1,5,5-tris(4-dimethylaminophenyl)-2,4-pentadienylidene]-2,5-cyclohexadien-1-ylidene}ammonium perchlorate (IR-800), 1,1′-Diethyl-4,4′-dicarbocyanine iodide, HITC, Dimethyl{4-[1,7,7-tris(4-dimethylaminophenyl)-2,4,6-heptatrienylidene]-2,5-cyclohexadien-1-ylidene}ammonium perchlorate (IR-895), [2-[2-Chloro-3-[[1,3-dihydro-1,1-dimethyl-3-(4-sulfobutyl)-2H-benzo[e]indol-2-ylidene]-ethylidene]-1-cyclohexen-1-yl]-ethenyl]-1,1-dimethyl-3-(4-sulfobutyl)-1H-benzo[e]indolium hydroxide inner salt (IR-820), Naphthol Green B, 2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl)-3H-indolium hydroxide (IR-783), 2-[2-[2-Chloro-3-[2-(1,3-dihydro-1,3,3-trimethyl-2H-indol-2-ylidene)-ethylidene]-1-cyclohexen-1-yl]-ethenyl]-1,3,3-trimethyl-3H-indolium chloride (IR-775 chloride), 2-[7-[1,3-Dihydro-3,3-dimethyl-1-(4-sulfobutyl)-2H-indol-2-ylidene]-hepta-1,3,5-trienyl]-3,3-dimethyl-1-(4-sulfobutyl)-3H-indolium hydroxide (IR-746), IR 144 and mixtures thereof.

### Cover Layer Preparation

The cover layers of the present disclosure can be made by any method well known in the art. In one embodiment, the laser dye is a powder laser dye. In one embodiment, a powder laser dye can be added to a soluble polymeric matrix material in solvent or the laser dye can be dissolved in solvent and mixed with the soluble polymeric matrix material in solvent. The solution is mixed. The solution may or may not be filtered. Any wet coating method may be used to coat the cover layer solution on to a carrier film. In some embodiments, a doctor knife is used to coat the laser dye, soluble polymeric matrix material solution on to a carrier film. The coating is heated to remove solvent. In some embodiments the carrier film is a polyester film.

In some embodiments, the cover layer (with carrier film) can be applied to the insulating substrate by dry film lamination. The carrier film on the cover layer is removed. In some embodiments, heat and pressure are used to laminate the cover layer to the insulating substrate. In some embodiments, the cover layer is laminated onto the insulating substrate surface in a vacuum press. The pressure and temperature of the vacuum press will be determined by the cover layer and insulating substrate used. In some embodiments, the vacuum press is heated to between and optionally including 60, 65, 70, 75, 80, 85 and 90 degrees Celsius. In some embodiments, the pressure of the vacuum press is between and optionally including 150, 160, 170, 180, 190, 200, 210, 220, 230, 240 and 250 psi.

In another embodiment the cover layer can be applied to the insulating substrate by any wet coating method or any other method by known by a person of ordinary skill in the art. In some embodiments, the insulating substrate is cured prior to applying the cover layer. When a wet method is used, the cover layer is heated and dried to remove any solvent. In some embodiments, the surface of the insulating substrate may be wiped down with isopropyl alcohol to remove any surface contamination, to improve adhesion.

### Insulating Substrate

In some embodiments, the insulating substrate comprises at least 50 weight % of an insulating polymeric matrix material. In some embodiments, the insulating substrate comprises an amount between and optionally including 50, 55, 60, 65, 70, 75, 80, 85, 90, 95, 97 and 100 weight % of an insulating polymeric matrix material. In one embodiment, the insulating polymeric matrix material is a polyimide. In another embodiment, the insulating polymeric matrix material is an epoxy resin. In some embodiments, the epoxy resin is a glass fiber reinforced epoxy resin or silica filled epoxy resin. In yet another embodiment, the insulating polymeric matrix material is selected from the group consisting of phenol-formaldehyde, bismaleimide resin, bismaleimide triazine, fluoropolymer, liquid crystal polymer and mixtures thereof. In another embodiment, the insulating polymeric matrix material is selected from the group consisting of polyester, polyphenylene oxide/polyphenylene ether resin, polybutadiene/polyisoprene crosslinkable resin and copolymers thereof, polyamide, cyanate ester, and mixtures thereof. In some embodiments, mixtures of insulating polymeric materials are used. In some embodiments, the insulating polymeric matrix material is a mixture of a polyimide resin and an epoxy resin. In some embodiments, the insulating polymeric matrix material is selected from the group consisting of:
polyimide,
glass fiber reinforced epoxy,
phenol-formaldehyde,
epoxy resin,
silica filled epoxy,
bismaleimide resin,
bismaleimide triazine,
fluoropolymer,
liquid crystal polymer
and mixtures thereof.

In one embodiment, examples of suitable epoxy resins, include, but are not limited to, glycidyl ether type epoxy resin, glycidyl ester resin and glycidylamine type epoxy resin. In addition, any silica or alumina-filled epoxies are also suitable.

Examples of suitable glycidyl ether type epoxy resins include, but are not limited to, bisphenol A type, bisphenol F type, brominated bisphenol A type, hydrogenated bisphenol A type, bisphenol S type, bisphenol AF type, biphenyl type, naphthalene type, fluorene type, phenol novolac type, cresol novolac type, DPP novolac type, trifunctional type, tris(hydroxyphenyl)methane type, and tetraphenylolethane type epoxy resins.

Examples of suitable glycidyl ester type epoxy resins include, but are not limited to, hexahydrophthalate type and phthalate type epoxy resins.

Examples of suitable glycidylamine type epoxy resins include, but are not limited to, tetraglycidyldiaminodiphenylmethane, triglycidyl isocyanurate, hydantoin type, 1,3-bis(N,N-diglycidylaminomethyl)cyclohexane, aminophenol type, aniline type, and toluidine type epoxy resins.

In one embodiment, the insulating polymeric matrix material may be a polyester. Examples of suitable polyesters include, but are not limited to, polyethylene terephthalate, polybutylene terephthalate, poly(trimethylene)terephthalate, etc., poly(e-caprolactone), polycarbonate, poly(ethylene-2,6-naphthalate), poly(glycolic acid), poly(4-hydroxy benzoic acid)-co-poly(ethyleneterephthalate) (PHBA), and poly(hydroxybutyrate).

In another embodiment, the insulating polymeric matrix material may be a polyamide. Examples of suitable aliphatic polyamides include, but are not limited to, nylon 6, nylon 6,6, nylon 6,10, nylon 6,12, nylon 3, nylon 4,6 and copolymers thereof are useful with this invention. Examples of aliphatic aromatic polyamides include, but are not limited to, nylon 6T (or nylon 6(3)T), nylon 10T and copolymers thereof, nylon 11, nylon 12 and nylon MXD6 are also suitable for use with this invention. Examples of aromatic polyamides include, but are not limited to, poly(p-phenylene terephthalamide), poly(p-benzamide), and poly(m-phenylene isophthalamide) are also suitable for use with this invention.

In another embodiment, the insulating polymeric matrix material may be a fluoropolymer. The term fluoropolymer is intended to mean any polymer having at least one, if not more, fluorine atoms contained within the repeating unit of the polymer structure. The term fluoropolymer, or fluoropolymer component, is also intended to mean a fluoropolymer resin (i.e. a fluoro-resin). Commonly, fluoropolymers are polymeric material containing fluorine atoms covalently bonded to, or with, the repeating molecule of the polymer. Suitable fluoropolymer components include, but are not limited to:
1. “PFA”, a poly(tetrafluoroethylene-co-perfluoro[alkyl vinyl ether]), including variations or derivatives thereof, having the following moiety representing at least 50, 60, 70, 80, 85, 90, 95, 96, 97, 98, 99 or about 100 weight percent of the entire polymer:

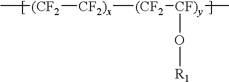

where R₁ is CₙF₂ₙ₊₁, where n can be any natural number equal to or greater than 1 including up to 20 or more, typically n is equal to 1 to three, where x and y are mole fractions, where x is in a range from 0.95 to 0.99, typically 0.97, and where y is in a range from 0.01 to 0.05, typically 0.03, and where the melt flow rate, described in ASTM D 1238, is in a range of from 1 to 100 (g/10 min.), preferably 1 to 50 (g/10 min.), more preferably, 2 to 30 (g/10 min.), and most preferably 5 to 25 (g/10 min.).
2. “FEP”, a poly(tetrafluoroethylene-co-hexafluoropropylene) [a.k.a. poly(tetrafluoroethylene-co-hexafluoropropylene)copolymer], derived in whole or in part from tetrafluoroethylene and hexafluoropropylene, including variations or derivatives thereof, having the following moiety representing at least 50, 60, 70, 80, 85, 90, 95, 96, 97, 98, 99 or about 100 weight percent of the entire polymer:

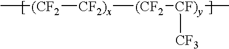

where x and y are mole fractions, where x is in a range from 0.85 to 0.95, typically 0.92, and where y is in a range from 0.05 to 0.15, typically 0.08, and where the melt flow rate, described in ASTM D 1238, is in a range of from 1 to 100 (g/10 min.), preferably 1 to 50 (g/10 min.), more preferably, 2 to 30 (g/10 min.), and most preferably 5 to 25 (g/10 min.).
The FEP copolymer can be derived directly or indirectly from: (i.) 50, 55, 60, 65, 70 or 75 percent to about 75, 80, 85, 90 or 95 percent tetrafluoroethylene; and (ii.) 5, 10, 15, 20, or 25 percent to about 25, 30, 35, 40, 45 or 50 percent (generally 7 to 27 percent) hexafluoropropylene. Such FEP copolymers are well known and are described in U.S. Pat. Nos. 2,833,686 and 2,946,763.
3. “PTFE”, a polytetrafluoroethylene, including variations or derivatives thereof, derived in whole or in part from tetrafluoroethylene and having the following moiety representing at least 50, 60, 70, 80, 85, 90, 95, 96, 97, 98, 99 or about 100 weight percent of the entire polymer: where x is equal to any natural number between 50 and 500,000.
4. “ETFE”, a poly(ethylene-co-tetrafluoroethylene), including variations or derivatives thereof, derived in whole or in part from ethylene and tetrafluoroethylene and having the following moiety representing at least 50, 60, 70, 80, 85, 90, 95, 96, 97, 98, 99, or about 100 weight percent of the entire polymer:

(CH₂—CH₂)ₓ—(CF₂—CF₂)_{y}
where x and y are mole fractions, where x is in a range from 0.40 to 0.60, typically 0.50, and where y is in a range from 0.40 to 0.60, typically 0.50, and where the melt flow rate, described in ASTM D 1238, is in a range of from 1 to 100 (g/10 min.), preferably 1 to 50 (g/10 min.), more preferably, 2 to 30 (g/10 min.), and most preferably 5 to 25 (g/10 min.).

Advantageous characteristics of fluoropolymer resins include high-temperature stability, resistance to chemical attack, advantageous electrical properties (high-frequency properties in particular) low friction properties, and low tackiness. Other potentially useful fluoropolymer resins include the following:
1. chlorotrifluoroethylene polymer (CTFE);
2. tetrafluoroethylene chlorotrifluoroethylene copolymer (TFE/CTFE);
3. ethylene chlorotrifluoroethylene copolymer (ECTFE);
4. polyvinylidene fluoride (PVDF);
5. polyvinylfluoride (PVF); and
6. Teflon® AF (sold by E.I. du Pont de Nemours & Co.).

In yet another embodiment, the insulating polymeric matrix material may be a liquid crystal polymer or thermotropic liquid crystal polymer. Liquid crystal polymers generally include a fusible or melt processible polyamide or polyester. Liquid crystal polymers also include, but are not limited to, polyesteramides, polyesterimides, and polyazomethines. Commercial examples of liquid crystal polymers include the aromatic polyesters or poly(ester-amides) sold under the trademarks Zenite® (DuPont), VECTRA® (Hoechst), and XYDAR® (Amoco).

In one embodiment, the insulating polymeric matrix material may be a polyimide. In another embodiment, the insulating polymeric matrix material may be may be a precursor to a polyimide or a polyamic acid. Polyimides are typically synthesized by a polycondensation reaction involving the reaction of one or more diamines with one or more dianhydrides.

Examples of suitable dianhydrides include, but are not limited to, 1,2,5,6-naphthalene tetracarboxylic dianhydride, 1,4,5,8-naphthalene tetracarboxylic dianhydride, 2,3,6,7-naphthalene tetracarboxylic dianhydride, 2-(3′,4′-dicarboxyphenyl) 5,6-dicarboxybenzimidazole dianhydride, 2-(3′,4′-dicarboxyphenyl) 5,6-dicarboxybenzoxazole dianhydride, 2-(3′,4′-dicarboxyphenyl) 5,6-dicarboxybenzothiazole dianhydride, 2,2′,3,3′-benzophenone tetracarboxylic dianhydride, 2,3,3′,4′-benzophenone tetracarboxylic dianhydride, 3,3′,4,4′-benzophenone tetracarboxylic dianhydride (BTDA), 2,2′,3,3′-biphenyl tetracarboxylic dianhydride, 2,3,3′,4′-biphenyl tetracarboxylic dianhydride, 3,3′,4,4′-biphenyl tetracarboxylic dianhydride (BPDA), bicyclo-[2,2,2]-octen-(7)-2,3,5,6-tetracarboxylic-2,3,5,6-dianhydride, 4,4′-thio-diphthalic anhydride, bis(3,4-dicarboxyphenyl)sulfone dianhydride, bis(3,4-dicarboxyphenyl)sulfoxide dianhydride (DSDA), bis(3,4-dicarboxyphenyl oxadiazole-1,3,4) p-phenylene dianhydride, bis(3,4-dicarboxyphenyl) 2,5-oxadiazole 1,3,4-dianhydride, bis 2,5-(3′,4′-dicarboxydiphenylether) 1,3,4-oxadiazole dianhydride, 4,4′-oxydiphthalic anhydride (ODPA), bis(3,4-dicarboxyphenyl)thio ether dianhydride, 2,2′-bis[4-(3,4-dicarboxyphenoxy)phenyl]propane dianhydride (BPADA), 2,2-bis-(3,4-dicarboxyphenyl) 1,1,1,3,3,3,-hexafluoropropane dianhydride (6FDA), 5,5-[2,2,2]-trifluoro-1-(trifluoromethyl)ethylidene, bis-1,3-isobenzofurandione, 1,4-bis(4,4′-oxyphthalic anhydride)benzene, bis(3,4-dicarboxyphenyl)methane dianhydride, cyclopentadienyl tetracarboxylic acid dianhydride, cyclopentane tetracarboxylic dianhydride, ethylene tetracarboxylic acid dianhydride, perylene 3,4,9,10-tetracarboxylic dianhydride, pyromellitic dianhydride (PMDA), tetrahydrofuran tetracarboxylic dianhydride, 1,3-bis-(4,4′-oxydiphthalic anhydride)benzene, 2,2-bis(3,4-dicarboxyphenyl)propane dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride; and thiophene-2,3,4,5-tetracarboxylic dianhydride.

Examples of suitable diamines include, but are not limited to, m-phenylenediamine, p-phenylenediamine, 2,5-dimethyl-1,4-diaminobenzene, trifluoromethyl-2,4-diaminobenzene, trifluoromethyl-3,5-diaminobenzene, 2,5-dimethyl-1,4-phenylenediamine (DPX), 2,2-bis-(4-aminophenyl)propane, 4,4′-diaminobiphenyl, 4,4′-diaminobenzophenone, 3,4′-diaminobenzophenone, 4,4′-diaminodiphenylmethane, 4,4′-diaminodiphenyl sulfide, 4,4′-diaminodiphenyl sulfone, 3,3′-diaminodiphenyl sulfone, bis-(4-(4-aminophenoxy)phenyl sulfone (BAPS), 4,4′-bis-(aminophenoxy)biphenyl (BAPB), 4,4′-diaminodiphenyl ether, 3,4′-diaminodiphenyl ether, 4,4′-isopropylidenedianiline, 2,2′-bis-(3-aminophenyl)propane, N,N-bis-(4-aminophenyl)-n-butylamine, N,N-bis-(4-aminophenyl)methylamine, 1,5-diaminonaphthalene, 3,3′-dimethyl-4,4′-diaminobiphenyl, m-amino benzoyl-p-amino anilide, 4-aminophenyl-3-aminobenzoate, N,N-bis-(4-aminophenyl)aniline, 2,4-diaminotoluene, 2,5-diaminotoluene, 2,6-diaminotoluene, 2,4-diamine-5-chlorotoluene, 2,4-diamine-6-chlorotoluene, 2,4-bis-(beta-amino-t-butyl)toluene, bis-(p-beta-amino-t-butyl phenyl)ether, p-bis-2-(2-methyl-4-aminopentyl)benzene, m-xylylene diamine, and p-xylylene diamine, 1,2-bis-(4-aminophenoxy)benzene, 1,3-bis-(4-aminophenoxy)benzene, 1,2-bis-(3-aminophenoxy)benzene, 1,3-bis-(3-aminophenoxy)benzene, 1-(4-aminophenoxy)-3-(3-aminophenoxy)benzene, 1,4-bis-(4-aminophenoxy)benzene, 1,4-bis-(3-aminophenoxy)benzene, 1-(4-aminophenoxy)-4-(3-aminophenoxy)benzene, 2,2-bis-(4-[4-aminophenoxy]phenyl)propane (BAPP), 2,2′-bis-(4-aminophenyl)-hexafluoro propane (6F diamine), 2,2′-bis-(4-phenoxy aniline)isopropylidene, 2,4,6-trimethyl-1,3-diaminobenzene, 4,4′-diamino-2,2′-trifluoromethyl diphenyloxide, 3,3′-diamino-5,5′-trifluoromethyl diphenyloxide, 4,4′-trifluoromethyl-2,2′-diaminobiphenyl, 2,4,6-trimethyl-1,3-diaminobenzene, 4,4′-oxy-bis-[2-trifluoromethyl)benzene amine] (1,2,4-OBABTF), 4,4′-oxy-bis-[3-trifluoromethyl)benzene amine], 4,4′-thio-bis-[(2-trifluoromethyl)benzene-amine], 4,4′-thiobis[(3-trifluoromethyl)benzene amine], 4,4′-sulfoxyl-bis-[(2-trifluoromethyl)benzene amine, 4,4′-sulfoxyl-bis-[(3-trifluoromethyl)benzene amine], and 4,4′-keto-bis-[(2-trifluoromethyl)benzene amine], 1,4-tetramethylenediamine, 1,5-pentamethylenediamine (PMD), hexamethylene diamine (HMD), 1,7-heptamethylene diamine, 1,8-octamethylenediamine, 1,9-nonamethylenediamine, 1,10-decamethylenediamine (DMD), 1,11-undecamethylenediamine, 1,12-dodecamethylenediamine (DDD), 1,16-hexadecamethylenediamine.

In some embodiments, the insulating substrate matrix material may include one or more additives such as, non-conductive fillers, pigments, viscosity modifiers, dispersants and other common additives known in the art. In some embodiments the insulating substrate contains a laser dye present in the amount between and optionally including 0.1, 0.2, 0.4, 0.6, 0.8, 1, 2, 4, 6, 10, 12, 14, 16, 18 and 20 weight percent. In some embodiments, the insulating substrate further comprises from 0.1 to 20 weight % of a laser dye. In another embodiment, any one of the cover layers, used individually or in combination, and the insulating substrate all contain a laser dye.

In one embodiment, the insulating substrate further comprises a laser light activatable metal oxide interspersed within the insulating matrix material. In some embodiments, the insulating substrate further comprises an amount between and optionally including 3, 5, 10, 15, 20, 25, 30, 35, 40, 45, 50, 55 and 60 weight % of a laser light activatable metal oxide. In some embodiments, the insulating substrate further comprises from 3 to 60 weight % of a laser light activatable metal oxide. The laser light activatable metal oxide allows for efficient and accurate surface patterning of circuitry features. If the insulating substrate contains too much laser light activatable metal oxide, it can sometimes be too brittle to handle in downstream processing as the insulting substrate will tend to lose flexibility with higher loadings of filler.

In one embodiment, the laser light activatable metal oxide comprises two or more metal oxide cluster configurations within a definable crystal formation. The overall crystal formation, when in an ideal (i.e., non-contaminated, non-derivative) state, the laser light activatable metal oxide has a crystal formation with the general formula AB₂O₄ or derivatives thereof.

In some embodiments, A is a metal cation having a valance of 2, selected from a group consisting of cadmium, manganese, nickel, zinc, copper, cobalt, iron, magnesium, tin, titanium, aluminum, chromium and combinations thereof, where A provides a primary cation component of a first metal oxide cluster, the first metal oxide cluster being a tetrahedral structure. In some embodiments, B is a metal cation having a valance of 3, selected from a group consisting of cadmium, manganese, nickel, zinc, copper, cobalt, iron, magnesium, tin, titanium, aluminum, chromium and combinations thereof, where B provides a primary cation component of a second metal oxide cluster, the second metal oxide cluster having an octahedral structure. O is oxygen. The first metal oxide cluster and the second metal oxide cluster together provide a singular identifiable crystal structure. The described crystal structure is commonly referred to as a spinel crystal structure and the metal oxides having that crystal structure are commonly referred to as spinels or spinel crystal fillers.

In another embodiment, within the above groups A and B, any metal cation having a possible valence of 2 can be used as an “A” cation. In addition, any metal cation having a possible valence of 3 can be used as a “B” cation provided that the geometric configuration of “metal oxide cluster 1” is different from the geometric configuration of “metal oxide cluster 2”. In yet another embodiment, A and B can be used as the metal cation of “metal oxide cluster 2” (typically the octahedral structure). This is true in the particular case of an ‘inverse’ spinel type crystal structure typically having the general formula B(AB)O₄.

In some embodiments, the insulating substrate may contain both a laser light activatable metal oxide and a laser dye.

One advantage of having a laser light activatable metal oxide interspersed within the insulating substrate is elimination of the additional step of depositing a layer of activatable material on the insulating substrate can be eliminated. A second advantage of having a laser light activatable metal oxide interspersed within the insulating substrate is a thinner circuit board. Adding a layer of activatable material increases the overall thickness of the circuit board when the trend is to produce thinner, smaller boards.

Many polymer films, even films containing relatively high loadings of other types of spinel crystal fillers, may be incapable of absorbing enough light energy to work effectively in high-speed, light activation manufacturing, as well as being able to receive plating of a metal in well-defined circuit patterns. High speed herein denotes a linear speed of greater than or equal to 100 millimeters per second per laser beam.

In one embodiment, when the insulating substrate contains laser light activated metal oxide(s), laser generated debris deposited on the surface of a cover layer will be activated due to the laser ablation process. Such activated debris 16 will tend to act as a metallization primer during metallization, as shown in FIG. 3B, causing metal 24 to form upon the debris as the laser ablated trough 18 (or via 20) is filled with metal 22 during metallization. When the strippable cover layer is removed, any plated debris is removed as show in FIG. 3C. Metallization of the ablation debris is generally undesirable and can lead to problems in electrical performance and/or reliability of the final printed wiring board product.

### Insulating Substrate Preparation

The insulating polymeric matrix materials can be made by methods well known in the art and many are commercially available. Useful organic solvents for the preparation of the insulating polymeric matrix material should be capable of dissolving the insulating substrate matrix material. A suitable solvent should also have a suitable boiling point, for example, below 225° C., so the polymer solution can be dried at moderate (i.e., more convenient and less costly) temperatures. A boiling point of less than 210, 205, 200, 195, 190, 180, 170, 160, 150, 140, 130, 120 or 110° C. is suitable.

In some embodiments, the insulating substrate can be made by casting a solution of the insulating polymeric matrix material on to first protective cover sheet by any wet coating method then heated to remove solvent. In some embodiments, the first protective coversheet is a polyester. In some embodiments, a second protective cover sheet may be applied to the opposite side of the insulating substrate from the first protective coversheet upon wind up. In some embodiments, the second protective coversheet is a polyethylene.

In one embodiment, when a laser light activatable metal oxide is present in the insulating polymeric matrix material, the insulating substrate is prepared by solvating the insulating polymeric matrix material to a sufficiently low viscosity (typically, a viscosity of less than 50, 40, 30, 20, 15, 10, 9, 8, 7, 6, 5, 4, 3, 2, 1.5, 1, 0.5, 0.1, 0.05, and 0.001 kiloPoise) to allow the laser light activatable metal oxide to be adequately dispersed within the insulating polymeric matrix material solution. In some embodiments, the laser light activatable metal oxide can be dispersed in the insulating polymeric matrix material solution directly, or can be dispersed in a solvent similar or the same as the insulating polymeric matrix material to form a slurry prior to dispersion in the insulating polymeric matrix material solution. In some embodiments, the laser light activatable metal oxide can be mixed in a solvent to form a dispersion, until the particles have reached an average particle size of between and optionally including any two of the following numbers 50, 100, 300, 500, 800, 1000, 2000, 3000, 4000, 5000, and 10000 nanometers. Generally, at least 80, 85, 90, 92, 94, 95, 96, 98, 99 or 100 percent of the dispersed laser light activatable metal oxide is within the above size range(s). The dispersion may then be mixed using a high-speed, or high-shear, mixing apparatus. The laser light activatable metal oxide may be dispersed using various suitable solvents. In some cases, the dispersions may also include one or more suitable dispersing agents known to a skilled artisan for assistance in forming a stable dispersion, particularly for commercial scale production. Crystal size, in the insulating polymeric matrix material solution, can be determined by a laser particle analyzer, such as an LS130 particle size analyzer with small volume module made by COULTER®.

However the laser light activatable metal oxide insulating polymeric matrix material dispersion is prepared, the dispersion of the laser light activatable metal oxide is conducted in such a manner as to avoid undue agglomeration of the particles in the solution or the dispersion. Unwanted agglomeration of the laser light activatable metal oxide can cause unwanted interfacial voids, or other problems in the insulating substrate. Undesirable agglomerates are defined as a collection of bound (adjoining) laser light activatable metal oxide having an average particle size of greater than 10, 11, 12, 13, 14, or 15 micrometers. In some embodiments, laser light activatable metal oxide may require some milling or filtration to break up unwanted particle agglomeration for adequately dispersing nano-sized fillers into a polymer.

In one embodiment, the laser light activatable metal oxide containing insulating polymeric matrix material solution is cast onto a flat surface or drum, heated, dried, and cured or semi-cured to form an insulating substrate. In another embodiment, the laser light activatable metal oxide containing insulating polymeric matrix material solution is cast on to a protective coversheet.

Laser patterning (laser ablation or laser ablating) involves removal of material in three dimensions due to thermal, photo-chemical or photo-mechanical reactions resulting from absorption of laser energy. The laser patterning process of the present disclosure does not involve the use of a mask.

The energy of a laser pulse is ideally characterized as gaussian in the spatial dimensions (x, y and z). In practice, imperfections in the laser, optics and atmosphere tend to transform a Gaussian beam profile and increase the minimum spot size. One technique used to improve the Gaussian spot is to place an aperture in front of the beam to eliminate extraneous laser energy off-axis from the intended target. In the practice of high volume circuit board manufacturing, this technique is impractical. When placing an aperture near the lens the placement results in a significant loss of useable energy. Placing the aperture near the circuit board precursor creates challenges to motion control and is also impractical. Using cover layers of the present disclosure allows circuitry feature size to be minimized by protecting the insulating substrate from extraneous (low fluence) laser energy, but is easily ablated due to being strongly absorbed by the (high fluence) laser energy at its intended target. Fluence is the energy per unit area or energy density. The cover layer cuts off the low fluence or extraneous energy so that it never reaches the insulating substrate creating finer circuitry features on the insulating substrate than if a cover layer is not used. The cover layers of the present disclosure ablate faster than the insulating substrate due to the addition of the laser dye. In some embodiments, with out a laser dye, the cover layer may not ablate.

Polymeric materials themselves are capable of absorbing some radiation. Different polymeric materials will absorb different amounts of radiation. In some embodiments, depending on the insulating polymeric matrix material selected, additional fillers, such as a laser dye, may be added to enhance energy absorption of the insulating polymeric matrix material. The laser dye in the insulating polymeric matrix material may be the same or different from the laser dye in the cover layer so long as the dye is capable of absorbing laser energy at the wavelength of the laser used.

The type of laser used and the laser conditions, such as average power and scan speed, can impact circuit feature size. In some embodiments, the average power is between and optionally including 0.25, 0.50, 0.75, 1.00, 1.50, 2.00, 2.50, 3.00, 4.00 and 4.10 watts. In some embodiments, the average scan speed is between and optionally including 100, 200, 300, 400, 500, 600, 700, 800, 900, 1000, 1100, 1200, 1300, 1400, 1500 and 1600 mm/s. In some embodiment, useful laser systems emit wavelengths in between and optionally including 0.2, 0.3, 0.355, 0.4, 0.5, 0.532, 0.6, 0.7, 0.8, 0.9, 1.0, 1.06, 1.1, 1.2, 1.3, 1.4, 1.5, 1.6, 1.7, 1.8, 1.9, 2.0, 5, 10, and 10.6 micrometers.

In one embodiment, when the cover layer is a sacrificial cover layer, the method of obtaining circuitry features comprises:

(1) positioning a circuit board precursor in proximity to a source of laser radiation, the circuit board precursor comprising;
a. a sacrificial cover layer comprising:
   i. 80 to 99 weight % of a water soluble polymeric matrix material, wherein at least 89 weight % of the water soluble polymeric matrix material is derived from a thermally stable hydrophilic monomer selected the group consisting of:
   acrylamide,
   ethylene oxide,
   propylene oxide,
   vinyl pyrrolydinone,
   acrylic acid,
   methacrylic acid,
   maleic acid,
   mixtures and derivatives thereof, and
   ii. 0.1 to 20 weight % of a laser dye;
b. an insulating substrate comprising at least 50 weight % of a insulating polymeric matrix material;

(2) selectively laser ablating through the sacrificial cover layer and into at least a portion of the insulating substrate at a average power between and including 0.25 and 4.10 watts, for a average scan speed between and including 100 and 1600 mm/s.

(3) treating with water, dilute alkali solution or dilute acid solution to remove the sacrificial cover layer to reveal one or more non-metalized circuitry features on the insulating substrate, wherein the circuitry features are at least 2% smaller in the narrowest orthogonal width dimension than a corresponding orthogonal width dimension of the circuitry features when a sacrificial cover layer is not used.

In some embodiments, the method comprises an additional step of metalizing the non-metalized circuitry features on the insulating substrate after removal of the sacrificial layer.

Typically, high speed circuit board manufacturing requires use of a vision system to determine the focal plane for laser ablation. The vision system focuses in and out (typically automatically) to locate surface features. Computer algorithms are used to determine the position of the focusing lens that results in minimum relative size of the identified surface features. In all cases, the top surface of the material being ablated is defined as the focal plane by this vision system. The laser is focused such that the minimum spot size of the laser is coplanar to the top surface of the material being ablated as defined by the vision system.

In another embodiment, when the cover layer is a strippable cover layer, the method of obtaining circuitry features comprises

(1) positioning a circuit board precursor in proximity to a source of laser radiation, the circuit board precursor comprising;
a. a strippable cover layer comprising:
   i. 80 to 99 weight % of a soluble polymeric matrix material selected from the group consisting of chitosan, methylglycol chitosan, chitosan oligosaccharide lactate, glycol chitosan, poly(vinyl imidazole), polyallylamine, polyvinylamine, polyetheramine, cyclen(cyclic polyamine), polyethylene amine(linear, or branched, or benzylated), poly(N-methylvinylamine), polyoxyethylene bis(amine), N′-(4-Benzyloxy)-N,N-dimethylformamidine polymer-bound (amidine resin), poly(ethylene glycol)bis(2-aminoethyl), poly(2-vinylpyridine), poly(4-vinylpyridine), poly(2-vinylpyridine N-oxide), poly(4-vinylpyridine N-oxide), poly(4-vinylpyridine-co-divinylbenzene), poly(2-vinylpyridine-co-styrene), poly(4-vinylpyridine-co-styrene), poly(4-vinylpyridine)-2% crosslinked, poly(4-aminostyrene), poly(aminomethyl)polystyrene, poly(dimethylaminoethylmethacrylate), poly(t-butylaminotheylmethacrylate), poly(dimethylaminoethylmethacrylate), poly(aminoethylmethacrylate), copolymer of styrene and dimethylaminopropylamine maleimide, and mixtures thereof.
   ii. 1 to 20 weight % of a laser dye;
b. an insulating substrate comprising at least 50 weight % of a insulating polymeric matrix material,

(2) selectively laser ablating through the strippable cover layer and into at least a portion of the insulating substrate at a average power between and including 0.25 and 4.10 watts, for a average scan speed between and including 100 and 1600 mm/s;

(3) metallizing; and

(4) treating with water or weak acid water mixtures to remove the strippable cover layer to reveal one or more metalized circuitry features on the insulating substrate, wherein the circuitry features are at least 2% smaller in the narrowest orthogonal width dimension than a corresponding orthogonal width dimension of the circuitry features when a sacrificial cover layer is not used.

When a sacrificial cover layer and a strippable cover layer are both used the method of obtaining circuitry features comprises

(1) positioning a circuit board precursor in proximity to a source of laser radiation, the circuit board precursor comprising:
a. a sacrificial cover layer comprising:
   i. 80 to 99 weight % of a water soluble polymeric matrix material, wherein at least 89 weight % of the water soluble polymeric matrix material is derived from a thermally stable hydrophilic monomer selected the group consisting of:
   acryamide,
   ethylene oxide,
   propylene oxide,
   vinyl pyrrolydinone,
   acrylic acid,
   methacrylic acid,
   maleic acid,
   mixtures and derivatives thereof, and
   ii. 0.1 to 20 weight % of a laser dye;
b. a strippable cover layer comprising:
   i. 80 to 99 weight % of a soluble polymeric matrix material selected from the group consisting of chitosan, methylglycol chitosan, chitosan oligosaccharide lactate, glycol chitosan, poly(vinyl imidazole), polyallylamine, polyvinylamine, polyetheramine, cyclen(cyclic polyamine), polyethylene amine(linear, or branched, or benzylated), poly(N-methylvinylamine), polyoxyethylene bis(amine), N′-(4-Benzyloxy)-N,N-dimethylformamidine polymer-bound (amidine resin), poly(ethylene glycol)bis(2-aminoethyl), poly(2-vinylpyridine), poly(4-vinylpyridine), poly(2-vinylpyridine N-oxide), poly(4-vinylpyridine N-oxide), poly(4-vinylpyridine-co-divinylbenzene), poly(2-vinylpyridine-co-styrene), poly(4-vinylpyridine-co-styrene), poly(4-vinylpyridine)-2% crosslinked, poly(4-aminostyrene), poly(aminomethyl)polystyrene, poly(dimethylaminoethylmethacrylate), poly(t-butylaminotheylmethacrylate), poly(dimethylaminoethylmethacrylate), poly(aminoethylmethacrylate), copolymer of styrene and dimethylaminopropylamine maleimide, and mixtures thereof.
   ii. 0.1 to 20 weight % of a laser dye;
c. an insulating substrate comprising at least 50 weight % of a insulating polymeric matrix material; and

wherein the sacrificial cover layer is adjacent to and in direct contact with the strippable layer and the insulating substrate is adjacent to and in direct contact with the strippable layer on the opposite side of the strippable layer from the sacrificial layer;

(2) selectively laser ablating through the sacrificial cover layer and the strippable cover layer and into at least a portion of the insulating substrate at a average power between and including 0.25 and 4.10 watts, for a average scan speed between and including 100 and 1600 mm/s

(3) treating with water, dilute alkali solution or dilute acid solution to remove the sacrificial cover layer

(4) metallizing and

(5) treating with water or weak acid water mixtures to remove the strippable cover layer to reveal one or more metalized circuitry features on the insulating substrate, wherein the circuitry features are at least 2% smaller in the narrowest orthogonal width dimension than a corresponding orthogonal width dimension of the circuitry features when a sacrificial cover layer is not used.

### Metallization

The present disclosure utilizes fully additive electroless plating. The number of processing steps employed to make a circuit using the polymer film or polymer composites are often far fewer relative to the number of steps in the subtractive processes.

The insulating substrate, with or without the cover layer depending on the cover layer used, is immersed in an alkaline cleaner with mild agitation for 90 seconds @ 50 degrees Celsius. Electroless copper chemistry is used to deposit a strike layer of copper. The insulating substrate is then immersed into a plating bath for 15 minutes resulting in 3-4 micrometers of copper being deposited in the laser activated locations of the insulating substrate. The mildly air agitated plating chemistry is operated at 50 degrees Celsius and bath concentrations were 11 mls/l formaldehyde, 7 g/l free sodium hydroxide, 2.5 g/l, and 2.5 g/l copper.

After the copper strike, the insulating substrate is moved to an electroless copper chemistry plating bath to deposit an additional 10-15 micrometers of electroless copper. The plating bath is maintained at 72 degrees Celsius, 1.8 g/l NaOH and 1.8 g/l formaldehyde, 2.5 g/l copper and an excess chelating agent of 18 g/l.

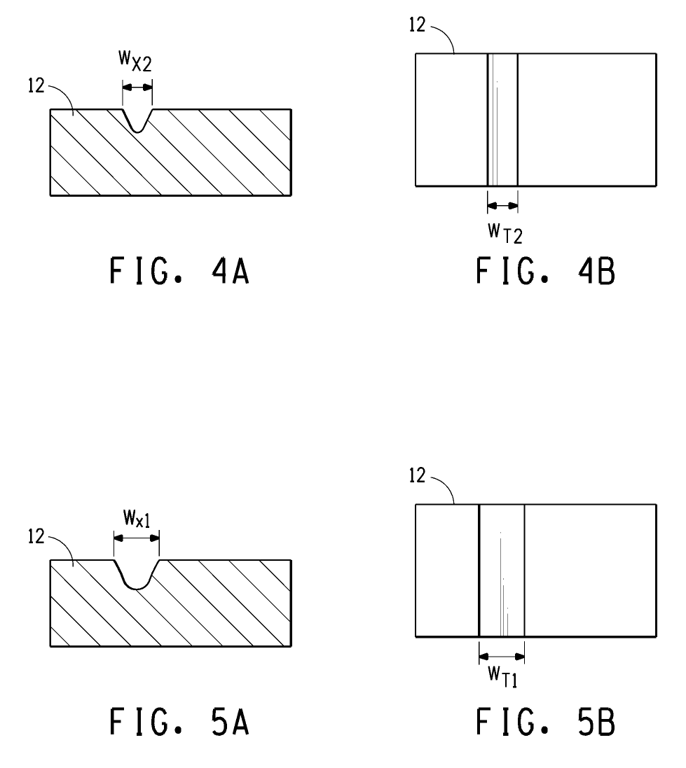

FIG. 4A includes a cross section of an insulating substrate after laser ablation wherein a sacrificial cover layer was used and removed. The width of the trench is measured as Wₓ₂.

FIG. 4B includes a top view of the insulating substrate after laser ablation wherein a sacrificial cover layer was used and removed. The width of the trench is measured as W_{T2}.

FIG. 5A includes a cross section of an insulating substrate after laser ablation when a cover layer is not used. The width of the trench is measured as Wₓ₁.

FIG. 5B includes a top view of the insulating substrate after laser ablation when a cover layer is not used. The width of the trench is measured as W_{T1}.

The circuitry features on an insulating substrate where a sacrificial cover layer is used and removed (FIGS. 4A and 4B) are generally finer when compared to circuitry features on an insulating substrate where a sacrificial cover layer is not used (FIGS. 5A and 5B).

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

### EXAMPLES

Many of the advantages of the present invention are illustrated in the following examples. Preparation of compositions, processing and procedures used in the examples of the present invention are described below.

### Insulating Substrate Preparation

A metal oxide slurry is prepared by first, dissolving 25 grams of dispersant Disperbyk-192 (a copolymer with pigment affinic groups made by BYK-Chemie GmbH) in 247.5 grams of acetone in a Netzsch commercially available media mill. The solvent is stirred at 1000 rpms. 250 grams of fine copper chromite spinel, CuCr₂O₄ powders (Shepherd Black 20C980) are added and allowed to mix for about 30 minutes. After which, the mean primary particle size in the slurry is measured to be 0.664 micrometers.

A 10 weight % filled epoxy composition is prepared by dissolving 7.20 grams of Dyhard™ 100SF (used as hardener, a Cyanoguanidine with anticaking agent from Degussa AG) and 10.80 grams of Dyhard™ UR500 (used as accelerator, a Carbamide compound from Degussa AG) in 162.00 grams of Epon™ 862 (a Bisphenol-F/Epichlorohydrin epoxy resin from Resolution Performance Products, LLP). The composition of Dyhard™ UR500 consists of >80% N,N″-(4-methyl-m-phenylene)bis(N′,N′-dimethylurea). After a homogeneous and viscous organic medium is attained, 20 grams of the pre-dispersed metal oxide slurry is added, and mixed thoroughly by hand or with a commercially available mixer. The composition is further processed on a three-roll mill to achieve a paste of consistent viscosity and dispersion. The viscosity for this composition is approximately 30-100 Pa.S measured on a Brookfield HBT viscometer using a #5 spindle at 10 rpm and 25° C.

### Insulating Substrate Lamination Process

A solution of insulating polymeric matrix material is cast on to a polyester protective cover sheet. Upon wind up, an additional polyethylene protective cover sheet is applied to the opposite side of the insulating substrate from the polyester protective cover layer.

The insulating substrate with protective cover sheets is applied to a pattern double sided or multi-layer core board, or interlayer board. Prior to the lamination step, the interlayer board is processed through an oxide treatment process to promote excellent bond strength of the patterned inner-layer copper to the insulating substrate. The interlayer board is typically pre-dried at 80-120 degrees Celsius for 15-60 minutes prior to lamination to remove surface absorbed moisture.

The protective polyethylene cover sheet on the insulating substrate is removed by manual peeling. One exposed insulating substrate is laid against the top of the interlayer copper treated board and a second exposed insulating substrate is laid against the bottom of the interlayer copper treated board. The layers are placed between the two press pads of a Meike Laminator. Both pads comprise an aluminum sheet and a tetrafluoroethylene hexafluoropropylene copolymer layer. The press cycle is 30 seconds under vacuum at 70 deg C. followed by 5 minutes at 1.0 MPA. Pressure is removed. The polyester coversheet/insulating substrate/Interlayer board/insulating substrate/polyester coversheet laminate is removed from the laminator and is allowed to cool.

The polyester coversheet is removed from the insulating substrate by manual peeling. The laminate is placed in a convection oven 50 deg C. for 60 minutes to remove residual solvents. The temperature is ramped to 90 deg C. and the laminate is baked for an additional 60 minutes. The temperature is then raised to 190 deg C. and the laminate is held at temperature for 90 minutes to cure the insulating substrate.

### Sacrificial Cover Layer Preparation

Two batch solutions are made. Batch A is made by dissolving 10 grams of Coumarin 460 (dye) in 90 grams of methanol. Batch B is made by dissolving 20 grams of polyvinyl pyrrolydinone in 80 grams of methanol. These two solutions are jar rolled (mixed) over night at room temperature. A 7 weight % dye loading final solution is made by mixing 3 grams of Batch A with 20 grams of methanol and then adding 20 grams from Batch B to the Batch A/methanol solution. This final solution is jar rolled for 2 hrs, then filtered through a 10 micro meter filter. The filtered final solution is coated with a doctor knife on to a polyester carrier film. A 190.5 micrometer doctor knife is used to obtain a final solution coating film thickness of 7-10 micrometers on the polyester carrier film. The film is dried at room temperature for one hour, followed by an 80° C. oven bake for 30 min.

### Sacrificial Cover Layer Lamination

The sacrificial cover layer is applied to the cured insulating substrate surface. To remove surface contamination, the surface of the cured insulating substrate may be wiped down with isopropyl alcohol to improve adhesion. The carrier film on the sacrificial cover layer is removed and the sacrificial cover layer is laminated onto the cured insulating substrate surface in a vacuum press @ 80 degrees Celsius @ 200 psi for 30 minutes.

### Laser Ablation Process

Two samples are subjected to laser ablation, one without a sacrificial cover layer and one with a sacrificial cover layer. The samples are individually loaded in a laser ablation system. This system utilizes a harmonically tripled solid state laser is used to define circuit traces. This system has a wavelength of approximately 355 nanometers. Details on the system used are disclosed in the individual examples. Each sample is exposed to a set of laser conditions, details of which are disclosed in the individual examples. Routed lines (trenches) are measured with a microscope using a 20× objective. Trenches are measured by viewing trenches directly prior to strike plating from the top. Trenches are also measured and by cross-sectioning after the circuit lines are plated.

### Strike Plating Process

After the laser imaging process, the imaged circuit board precursor is prepared for plating by washing off the sacrificial cover layer under warm water, 35-40 deg C. for 1 minute. Sacrificial cover layer is best removed under a spray rather than being immersed in the warm water. The insulating substrate is then immersed in an alkaline cleaner with mild agitation (Versaclean 415) for 90 seconds @ 50 degrees Celsius.

Enthone's EnPlate 9070 Electroless copper chemistry is used to deposit a strike layer of copper. The insulating substrate is immersed into the plating bath for 15 minutes and 3-4 micrometers of copper is deposited in the laser activated locations of the insulating substrate. The mildly air agitated plating chemistry is operated at 50 degrees Celsius and bath concentrations were 11 mls/l formaldehyde, 7 g/l free sodium hydroxide, 2.5 g/l, and 2.5 g/l copper.

After the copper strike, the insulating substrate is moved to the AMPlate 610 electroless copper chemistry to deposit an additional 10-15 micrometers of electroless copper. The plating bath is maintained at 72 degrees Celsius, 1.8 g/l NaOH and 1.8 g/l formaldehyde, 2.5 g/l copper and an excess chelating agent of 18 g/l.

### Example 1

Example 1 illustrates use of a sacrificial cover layer to generate finer circuit features on an insulating substrate compared to using an insulating substrate by itself. A modified Electro Scientific Industries Model 5650 is used to define circuit features. This system is fitted with an “ultrafast” laser in lieu of the standard laser used for this system. This developmental system has a pulse repetition rate of approximately 80 Megahertz, a pulse length of less than 50 picoseconds and a spot size of approximately 12 micrometers at the focal plane. The average power is set to discrete values between 0.25 Watts and 4.10 Watts. Vertical lines are scanned at scan speeds set to discrete values between 100 millimeters per second to 1600 millimeters per second. The beam profile of this laser is approximately Gaussian.

Refer to FIGS. 4A, 4B, 5A, and 5B for details regarding how the widths are identified. Measurement of the trench widths using a microscope viewing trenches from the top are summarized in Table 1. The same trenches are strike plated and cross-sectioned. The ablated width at the top of the trench is measured under the same microscope. The results are summarized in Table 2.

TABLE 1
Line widths measured by top view using a microscope.

| Laser Conditions | | | | | | % |
|---|---|---|---|---|---|---|
| Avg Power | Scan Speed | W_{T1} (μm) | | W_{T2} (μm) | | difference |
| (W) | (mm/s) | Avg | StDev | Avg | StDev | (%) |
| 0.25 | 400 | 18.0 | 0.4 | 16.8 | 0.5 | −7% |
| 0.25 | 800 | 10.0 | 0.5 | 5.1 | 1.3 | −64% |
| 0.25 | 1600 | 9.8 | 0.5 | 5.7 | 0.8 | −53% |
| 0.50 | 100 | 25.0 | 0.4 | 23.1 | 0.9 | −8% |
| 0.50 | 200 | 24.3 | 0.5 | 19.9 | 0.8 | −20% |
| 0.50 | 400 | 20.9 | 0.5 | 15.9 | 0.6 | −27% |
| 0.50 | 800 | 20.1 | 0.7 | 12.1 | 0.7 | −49% |
| 0.50 | 1600 | 16.0 | 0.8 | 5.6 | 1.1 | −97% |
| 1.00 | 800 | 20.3 | 0.7 | 17.0 | 0.7 | −18% |
| 1.00 | 1600 | 15.6 | 0.3 | 12.0 | 0.3 | −26% |
| 2.00 | 400 | 29.5 | 0.7 | 24.7 | 0.8 | −18% |
| 2.00 | 800 | 23.6 | 0.6 | 22.6 | 0.6 | −5% |
| 2.00 | 1600 | 19.5 | 0.5 | 17.0 | 0.4 | −14% |
| 4.10 | 400 | 39.1 | 0.9 | 29.3 | 0.8 | −29% |

TABLE 2
Line widths by cross section using a microscope.

| Laser Conditions | | | | | | % |
|---|---|---|---|---|---|---|
| Avg Power | Scan Speed | W_{X1} (μm) | | W_{X2} (μm) | | difference |
| (W) | (mm/s) | Avg | StDev | Avg | StDev | (%) |
| 0.25 | 400 | 18.3 | 0.5 | 12.1 | 0.5 | −41% |
| 0.25 | 800 | 9.6 | 0.6 | 6.7 | 1.6 | −35% |
| 0.25 | 1600 | 9.5 | 1.2 | 5.5 | 0.8 | −53% |
| 0.50 | 100 | 24.3 | 1.2 | 19.2 | 1.2 | −24% |
| 0.50 | 200 | 22.9 | 1.7 | 18.8 | 1.3 | −20% |
| 0.50 | 400 | 19.2 | 1.4 | 15.4 | 0.7 | −22% |
| 0.50 | 800 | 21.4 | 1.7 | 11.9 | 2.2 | −57% |
| 0.50 | 1600 | 16.5 | 1.3 | 5.7 | 0.6 | −97% |
| 1.00 | 800 | 21.1 | 1.0 | 17.7 | 0.8 | −17% |
| 1.00 | 1600 | 15.5 | 1.1 | 12.3 | 0.8 | −23% |
| 2.00 | 400 | 26.8 | 0.6 | 22.9 | 2.2 | −16% |
| 2.00 | 800 | 22.1 | 0.6 | 18.8 | 0.9 | −16% |
| 2.00 | 1600 | 18.2 | 0.8 | 17.4 | 1.2 | −4% |
| 4.10 | 400 | 36.1 | 1.7 | 30.6 | 1.2 | −16% |

### Example 2

Example 2 illustrates the use of a sacrificial cover layer to generate finer circuit features on an insulating substrate compared to using an insulating substrate by itself. An Electro Scientific Industries Model 5330 is used to define circuit features. This system is fitted with a standard laser used in the industry. This laser has a pulse repetition rate of approximately 42 kilohertz, a pulse length of approximately 100 nanoseconds and a spot size ranging between 12 micrometers and 60 micrometers at the focal plane. The average power is set to discrete values between 0.12 Watts and 4.0 Watts. Vertical lines are scanned at scan speeds set to discrete values between 100 millimeters per second to 400 millimeters per second. The beam profile of this laser is approximately Gaussian.

Refer to FIGS. 4A, 4B, 5A, and 5B for details regarding how the widths are identified. Measurement of the trench widths using a microscope viewing trenches from the top are summarized in Table 3. The same trenches are strike plated and cross-sectioned. The ablated width at the top of the trench is measured under the same microscope. The results are summarized in Table 4.

TABLE 3
Line widths by top view using a microscope.

| | Laser Conditions | | | | | | |
|---|---|---|---|---|---|---|---|
| Spot | Avg | Scan | | | | | |
| Size | Power | Speed | W_{T1} (μm) | | W_{T2} (μm) | | % difference |
| (μm) | (W) | (mm/s) | Avg | StDev | Avg | StDev | (%) |
| 18 | 0.60 | 100 | 41.3 | 1.7 | 36.3 | 0.7 | −13% |
| 18 | 1.20 | 100 | 50.0 | 1.2 | 45.5 | 0.7 | −9% |
| 18 | 1.00 | 400 | 36.4 | 1.2 | 29.3 | 0.7 | −22% |
| 18 | 4.00 | 400 | 50.9 | 1.7 | 41.2 | 0.9 | −21% |
| 60 | 0.50 | 100 | 50.9 | 0.7 | 43.4 | 1.0 | −16% |
| 60 | 4.00 | 400 | 65.8 | 1.4 | 58.1 | 1.7 | −12% |

TABLE 4
Line widths by cross section under a microscope.

| | Laser Conditions | | | | | | |
|---|---|---|---|---|---|---|---|
| Spot | Avg | Scan | | | | | |
| Size | Power | Speed | W_{X1} (μm) | | W_{X2} (μm) | | % difference |
| (μm) | (W) | (mm/s) | Avg | StDev | Avg | StDev | (%) |
| 18 | 0.60 | 100 | 40.3 | 0.7 | 37.0 | 2.0 | −9% |
| 18 | 1.20 | 100 | 48.7 | 1.6 | 44.4 | 2.2 | −9% |
| 18 | 1.00 | 400 | 33.8 | 0.3 | 28.8 | 0.6 | −16% |
| 18 | 4.00 | 400 | 48.4 | 1.0 | 43.3 | 2.0 | −11% |
| 60 | 0.50 | 100 | 51.4 | 0.6 | 44.6 | 0.4 | −14% |
| 60 | 4.00 | 400 | 67.0 | 2.0 | 58.9 | 0.3 | −13% |

### Example 3

Example 3 illustrates use of a sacrificial cover layer to generate finer circuit features on insulating substrate compared to using the insulated substrate itself. The material used is epoxy resin, GX-3, manufactured by Ajinomoto Fine-Techo Co., Inc. A modified Electro Scientific Industries Model 5650 is used to define circuit features. This system is fitted with an “ultrafast” laser in lieu of the standard laser used for this system. This developmental system has a pulse repetition rate of approximately 80 Megahertz, a pulse length of less than 50 picoseconds and a spot size of approximately 12 micrometers at the focal plane. The average power is set to values of 0.25 Watts and 0.50 Watts. Vertical lines are scanned at scan speeds set to discrete values of 200 millimeters per second to 400 millimeters per second. The beam profile of this laser is approximately Gaussian.

Refer to FIGS. 4A, 4B, 5A, and 5B for details regarding how the widths are identified. Measurement of the trench widths using a microscope viewing trenches from the top are summarized in Table 5. The same trenches are strike plated and cross-sectioned. The width at the top of the trench is measured under the same microscope. The results are summarized in Table 6.

TABLE 5
Line widths by top view using a microscope.

| Laser Conditions | | | | | | % |
|---|---|---|---|---|---|---|
| Avg Power | Scan Speed | W_{T1} (μm) | | W_{T2} (μm) | | difference |
| (W) | (mm/s) | Avg | StDev | Avg | StDev | (%) |
| 0.25 | 200 | 19.1 | 1.6 | 16.9 | 0.5 | −12% |
| 0.25 | 400 | 14.4 | 0.5 | 10.1 | 0.7 | −35% |
| 0.50 | 200 | 23.6 | 0.7 | 21.3 | 0.8 | −10% |
| 0.50 | 400 | 20.1 | 0.9 | 17.9 | 0.5 | −11% |

TABLE 6
Line widths by top view using a microscope.

| Laser Conditions | | | | | | % |
|---|---|---|---|---|---|---|
| Avg Power | Scan Speed | W_{X1} (μm) | | W_{X2} (μm) | | difference |
| (W) | (mm/s) | Avg | StDev | Avg | StDev | (%) |
| 0.25 | 200 | 17.1 | 0.7 | 16.2 | 1.1 | −5% |
| 0.25 | 400 | 14.8 | 0.2 | 12.1 | 0.4 | −20% |
| 0.50 | 200 | 22.0 | 0.4 | 21.6 | 1.0 | −2% |
| 0.50 | 400 | 20.9 | 0.4 | 15.9 | 1.4 | −27% |

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

What is claimed is:

1. A method of obtaining circuitry features, the method comprising:
(1) positioning a circuit board precursor in proximity to a source of laser radiation, the circuit board precursor comprising;
a. a sacrificial cover layer comprising:
i. 80 to 99 weight % of a water soluble polymeric matrix material, wherein at least 89 weight % of the water soluble polymeric matrix material is derived from a thermally stable hydrophilic monomer selected the group consisting of:
acryamide,
ethylene oxide,
propylene oxide,
vinyl pyrrolydinone,
acrylic acid,
methacrylic acid,
maleic acid,
mixtures and derivatives thereof, and
ii. 0.1 to 20 weight % of a laser dye;
b. an insulating substrate comprising at least 50 weight % of a insulating polymeric matrix material;
(2) selectively laser ablating through the sacrificial cover layer and into at least a portion of the insulating substrate at a average power between and including 0.25 and 4.10 watts, for a average scan speed between and including 100 and 1600 mm/s.
(3) treating with water, dilute alkali solution or dilute acid solution to remove the sacrificial cover layer to reveal one or more non-metalized circuitry features on the insulating substrate, wherein the circuitry features are at least 2% smaller in the narrowest orthogonal width dimension than a corresponding orthogonal width dimension of the circuitry features when a sacrificial cover layer is not used.

2. The method in accordance with claim 1 comprising an additional step of metalizing the non-metalized circuitry features on the insulating substrate after removal of the sacrificial layer.

3. The method in accordance with claim 1 wherein the insulating polymeric matrix material is selected from the group consisting of:
polyimide,
glass fiber reinforced epoxy,
phenol-formaldehyde,
epoxy resin,
silica filled epoxy,
bismaleimide resin,
bismaleimide triazine,
fluoropolymer,
liquid crystal polymer
and mixtures thereof.

4. The method in accordance with claim 1 wherein the laser dye has an absorption peak from 0.2 to 10.6 micrometers.

5. The method in accordance with claim 1 wherein the insulating substrate further comprises 3 to 60 weight % of a laser light activatable metal oxide; wherein the laser light activatable metal oxide has a crystal formation with the general formula:
AB₂O₄
or derivatives thereof,
wherein:
A is a metal cation having a valance of 2, selected from a group consisting of cadmium, manganese, nickel, zinc, copper, cobalt, iron, magnesium, tin, titanium, aluminum, chromium, and combinations thereof, where A provides a primary cation component of a first metal oxide cluster, the first metal oxide cluster being a tetrahedral structure;
B is a metal cation having a valance of 3, selected from a group consisting of cadmium, manganese, nickel, zinc, copper, cobalt, iron, magnesium, tin, titanium, aluminum, chromium and combinations thereof, where B provides a primary cation component of a second metal oxide cluster, the second metal oxide cluster having an octahedral structure;
where O is oxygen; and
where the first metal oxide cluster and the second metal oxide cluster together provide a singular identifiable crystal structure.

6. The method in accordance with claim 1 wherein the insulating substrate further comprising from 0.1 to 20 weight % of a laser dye.

7. A method of obtaining circuitry features, the method comprising:
(1) positioning a circuit board precursor in proximity to a laser beam source, the circuit board precursor comprising;
a. a strippable cover layer comprising:
i. 80 to 99 weight % of a soluble polymeric matrix material selected from the group consisting of chitosan, methylglycol chitosan, chitosan oligosaccharide lactate, glycol chitosan, poly(vinyl imidazole), polyallylamine, polyvinylamine, polyetheramine, cyclen(cyclic polyamine), polyethylene amine(linear, or branched, or benzylated), poly(N-methylvinylamine), polyoxyethylene bis(amine), N′-(4-Benzyloxy)-N,N-dimethylformamidine polymer-bound (amidine resin), poly(ethylene glycol)bis(2-aminoethyl), poly(2-vinylpyridine), poly(4-vinylpyridine), poly(2-vinylpyridine N-oxide), poly(4-vinylpyridine N-oxide), poly(4-vinylpyridine-co-divinylbenzene), poly(2-vinylpyridine-co-styrene), poly(4-vinylpyridine-co-styrene), poly(4-vinylpyridine)-2% crosslinked, poly(4-aminostyrene), poly(aminomethyl)polystyrene, poly(dimethylaminoethylmethacrylate), poly(t-butylaminotheylmethacrylate), poly(dimethylaminoethylmethacrylate), poly(aminoethylmethacrylate), copolymer of styrene and dimethylaminopropylamine maleimide, and mixtures thereof.
ii. 0.1 to 20 weight % of a laser dye;
b. an insulating substrate comprising at least 50 weight % of a insulating polymeric matrix material;
(2) selectively laser ablating through the strippable cover layer and into at least a portion of the insulating substrate at a average power between and including 0.25 and 4.10 watts, for a average scan speed between and including 100 and 1600 mm/s;
(3) metallizing; and
(4) treating with water or weak acid water mixtures to remove the strippable cover layer to reveal one or more metalized circuitry features on the insulating substrate, wherein the circuitry features are at least 2% smaller in the narrowest orthogonal width dimension than a corresponding orthogonal width dimension of the circuitry features when a sacrificial cover layer is not used.

8. A method of obtaining circuitry features, the method comprising:
(1) positioning a circuit board precursor in proximity to a source of laser radiation, the circuit board precursor comprising:
a. a sacrificial cover layer comprising:
i. 80 to 99 weight % of a water soluble polymeric matrix material, wherein at least 89 weight % of the water soluble polymeric matrix material is derived from a thermally stable hydrophilic monomer selected the group consisting of:
acryamide,
ethylene oxide,
propylene oxide,
vinyl pyrrolydinone,
acrylic acid,
methacrylic acid,
maleic acid,
mixtures and derivatives thereof, and
ii. 0.1 to 20 weight % of a laser dye;
b. a strippable cover layer comprising:
i. 80 to 99 weight % of a soluble polymeric matrix material selected from the group consisting of chitosan, methylglycol chitosan, chitosan oligosaccharide lactate, glycol chitosan, poly(vinyl imidazole), polyallylamine, polyvinylamine, polyetheramine, cyclen(cyclic polyamine), polyethylene amine(linear, or branched, or benzylated), poly(N-methylvinylamine), polyoxyethylene bis(amine), N′-(4-Benzyloxy)-N,N-dimethylformamidine polymer-bound (amidine resin), poly(ethylene glycol)bis(2-aminoethyl), poly(2-vinylpyridine), poly(4-vinylpyridine), poly(2-vinylpyridine N-oxide), poly(4-vinylpyridine N-oxide), poly(4-vinylpyridine-co-divinylbenzene), poly(2-vinylpyridine-co-styrene), poly(4-vinylpyridine-co-styrene), poly(4-vinylpyridine)-2% crosslinked, poly(4-aminostyrene), poly(aminomethyl)polystyrene, poly(dimethylaminoethylmethacrylate), poly(t-butylaminotheylmethacrylate), poly(dimethylaminoethylmethacrylate), poly(aminoethylmethacrylate), copolymer of styrene and dimethylaminopropylamine maleimide, and mixtures thereof.
ii. 0.1 to 20 weight % of a laser dye;
c. an insulating substrate comprising at least 50 weight % of a insulating polymeric matrix material; and
wherein the sacrificial cover layer is adjacent to and in direct contact with the strippable layer and the insulating substrate is adjacent to and in direct contact with the strippable layer on the opposite side of the strippable layer from the sacrificial layer;
(2) selectively laser ablating through the sacrificial cover layer and the strippable cover layer and into at least a portion of the insulating substrate at a average power between and including 0.25 and 4.10 watts, for a average scan speed between and including 100 and 1600 mm/s;
(3) treating with water, dilute alkali solution or dilute acid solution to remove the sacrificial cover layer;
(4) metallizing and
(5) treating with water or weak acid water mixtures to remove the strippable cover layer to reveal one or more metalized circuitry features on the insulating substrate, wherein the circuitry features are at least 2% smaller in the narrowest orthogonal width dimension than a corresponding orthogonal width dimension of the circuitry features when a sacrificial cover layer is not used.
